(19) United States
(12) Patent Application Publication
(10) Pub. No.: US 2011/0206217 A1
(43) Pub. Date: Aug. 25, 2011

(54) HEADSET SYSTEM WITH MICROPHONE FOR AMBIENT SOUNDS

(75) Inventor: Peter Weis, Allerod (DK)

(73) Assignee: GN Netcom A/S, Ballerup (DK)

(21) Appl. No.: 13/033,693

(22) Filed: Feb. 24, 2011

(30) Foreign Application Priority Data
Feb. 24, 2010 (EP) 10154525.9

(51) Int. Cl. H04R 1/10

(52) U.S. Cl. 381/74

(57) ABSTRACT

A communication headset system (1) for connecting to a two-way communication device (10). The communication headset system (1) comprising an earphone (15) with a speaker (2) for receiving a speaker signal (3) and converting it into speaker sound, a voice microphone (4) for receiving a user's voice and converting it into a voice signal (5). The communication headset system (1) further comprises an ambient microphone (6), arranged at a distance from the voice microphone (4), for receiving ambient sound and converting it into an ambient sound signal (7), and a control circuit (8) for receiving the ambient sound signal (7) and an input signal (12) from the telecommunication device (10), and for transmitting the speaker signal (3) to the speaker (2). The control circuit (8) comprises a switching circuit (9) for switching the headset system between an ambient mode in which the speaker signal (3) comprises the ambient sound signal (7) and not the input signal (12) and a communication mode in which the speaker signal (3) comprises the input signal (12) and not the ambient sound signal (7).

### TECHNICAL FIELD

The disclosure relates to a communication headset system using systems and methods for minimizing ambient sounds.

### BACKGROUND

Headsets for two-way communication become more and more popular. They are used in different setups, e.g. plain corded headsets connected to desk top phones, corded headsets in call centers, wireless office headsets following the DECT standard, corded and wireless Bluetooth headsets used with mobile phones. In these years, “unified communication” (UC) becomes more prevalent. Unified communication is the integration of real-time communication services such as instant messaging, presence information, IP telephony, video conferencing, call control and speech recognition with non real-time communication services such as unified messaging (integrated voicemail, e-mail, SMS and fax). This means, that more people will use headsets more often and in longer periods during the day. One of the main advantages by using a headset is that the user's hands are free during conversation for other purposes such as typing, handling papers etc. Especially when using a wireless headset, the user can walk around the office or go to a quite room in order not to disturb colleagues during long phone calls.

However, there is a disadvantage of wearing a headset. The earphone is more or less effective at blocking out external sounds, which can be undesirably in certain situations.

US 2001/0046304 discloses a headset with selective acoustical isolation from the external environment. The earphone sound listened to may be attenuated temporarily in the event of a certain external sound captured by a microphone. The external sound is amplified and directed to the speaker in what is termed a “hearthrough mode”.

WO 2007/085307 discloses an earphone with a through going channel, which can be in a closed state and an open state. In the open state, ambient sounds can pass through. The earphone may be configured to switch the channel to the closed state when speaking on the phone.

WO 2007/102047 discloses a headset with an ambient sound microphone. A processor combines ambient sound with audio from an electronic audio device.

WO 2008/051631 also discloses a headset with an ambient sound microphone. In normal use, the user hears a mix between audio from a connected device and the ambient sound. The ambient sound is switched off or disabled when a “predefined event” is detected.

As indicated above, the prior art disclose different solutions for avoiding the disadvantages of headsets blocking out ambient sounds, but there is still a need for a simple and reliable solution.

### SUMMARY

The following summary is intended to assist the reader in understanding the full disclosure and the claims. It is not intended to define or restrict the invention.

In one embodiment of the disclosure there is provided a communication headset system for connecting to a two-way communication device, said communication headset system comprising an earphone with a speaker for receiving a speaker signal and converting it into speaker sound, a voice microphone for receiving a user's voice and converting it into a voice signal, an ambient microphone arranged at a distance from the voice microphone for receiving ambient sound and converting it into an ambient sound signal, a control circuit for receiving the ambient sound signal and an input signal from the telecommunication device, and for transmitting the speaker signal to the speaker, wherein the control circuit comprises a switching circuit for switching the headset system between an ambient mode in which the speaker signal comprises the ambient sound signal and not the input signal and a communication mode in which the speaker signal comprises the input signal and not the ambient sound signal. With such a system, the user can simply switch between the ambient mode, in which he is not isolated from the ambient sounds, and the communication mode, in which he can concentrate on speak and hear sounds coming from the two-way communication device with minimum disturbance from the surroundings.

According to an embodiment, the control circuit is adapted to transmit an output signal comprising the voice signal to the two-way communication device in the communication mode.

Preferably, a user interface is provided for switching between the ambient mode and the communication mode. Thus, the user can select between the two modes.

According to a preferred embodiment, the control circuit is adapted to automatically enter the communication mode, when it receives an input signal from the two-way communication device. Thus, the user does not to have to manually select mode, when e.g. a phone call is accepted or ended.

The disclosure is especially advantageous, if the headset system comprises a first earphone and a second earphone, as such a headset system blocks out ambient sound from both ears.

The first earphone and the second earphone may be interconnected by a headband or a neckband.

According to an embodiment, the communication headset system comprises a headset housing, which comprises the ambient microphone.

According to an embodiment, the headset housing may be separate from the earphones.

Thus, the headset housing can be a body worn housing. In this case, the ambient microphone can be arranged a far distance from the user's mouth thereby catching the ambient sounds without the user's own voice becoming too predominating.

According to another embodiment, the headset housing is a headset base adapted to be placed on a surface, such as a desktop or a wall, during use. Also, in this case, the ambient microphone can be arranged at a suitable distance from the user's mouth.

According to yet another embodiment, an earphone comprises the ambient microphone.

In a specific embodiment, each of the first earphone and the second earphone comprises an ambient microphone. Such a configuration can be used for providing a spatial effect. Thus, the user's right ear hear ambient sound picked up by the ambient microphone on the right earphone while the user's left ear hear the ambient sound picked up by the ambient microphone on the left earphone.

The voice microphone may be arranged on a microphone boom in order to bring it closer to the user's mouth during use.

According to an embodiment, the control circuit is adapted to add the voice signal to the speaker signal in the communication mode. Hereby, the user can hear his own voice during two-way communications, and this feature is referred to as the “sidetone” effect.

The ambient microphone is preferably omnidirectional.

### BRIEF DESCRIPTION OF THE DRAWINGS

The disclosure is explained in detail below with reference to the drawing illustrating a preferred embodiment of the disclosure and in which:

FIG. 1 is a view of a first embodiment of a communication headset system according to the disclosure,

FIG. 2 a view of a second embodiment of a communication headset according to the disclosure,

FIG. 3 is a view a third embodiment of a communication headset according to the disclosure,

FIG. 4 is a view a fourth embodiment of a communication headset according to the disclosure,

FIG. 5 is a schematic diagram of a fifth embodiment of the disclosure in ambient mode,

FIG. 6 is a schematic diagram of the fifth embodiment of the disclosure in communication mode,

FIG. 7 is a state machine showing the two states of the headset system according to the disclosure,

FIG. 8 is a schematic diagram of a sixth embodiment of the disclosure in ambient mode, and

FIG. 9 is a schematic view of the headset according to the first embodiment in ambient mode.

### DETAILED DISCLOSURE

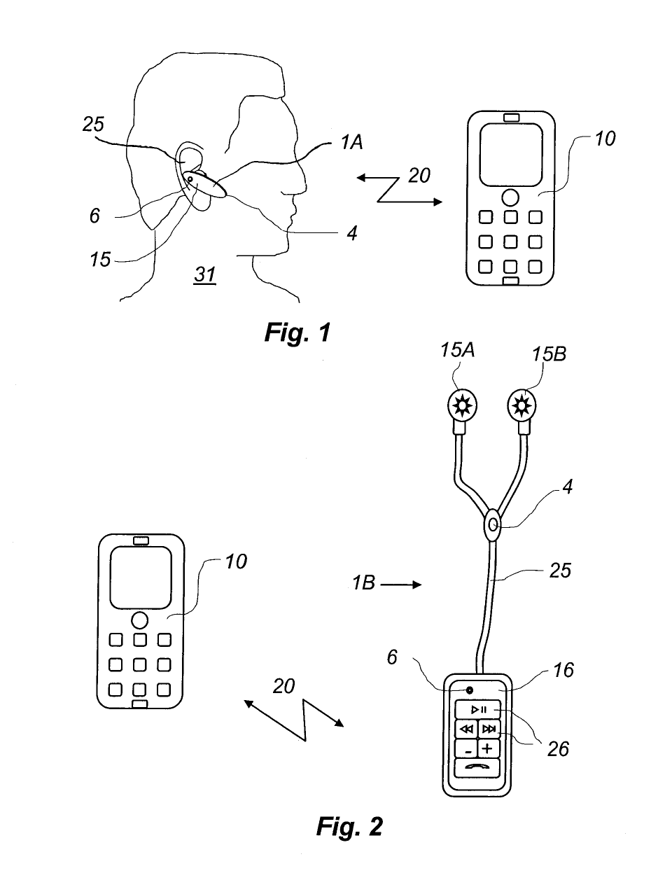

FIG. 1 discloses a headset system 1A according to a first embodiment of the disclosure. This embodiment is based on a conventional Bluetooth headset, which is especially intended for use with Bluetooth enabled mobile phones. It comprises an earphone 15, which is arranged at the outer ear 25 of a user 31. In this embodiment, the earphone 15 is attached by inserting a non-visible earbud in the ear. However, other attachment devices, such as an ear hook, ear loop, a headband, could be used. A Bluetooth transceiver in the earphone 15 is wirelessly connected by a Bluetooth link 20 to a Bluetooth transceiver in a mobile phone 10. The earphone housing is elongate and points in the direction of the mouth of the user 31. At the end of the earphone 15 closest to the mouth, the earphone 15 is provided with a conventional voice microphone 4 for picking up the user's voice during two-way communication via the mobile phone 10. At the opposite end of the earphone 15, an ambient microphone 6 is provided for picking up ambient sounds, when the user 31 is not on a phone call.

FIG. 2 discloses a second embodiment of a headset system 1B according to the disclosure. Two earphones 15A, 15B to be inserted into the ears of the user are connected by a wire 25 to a so-called body worn headset housing 16. A voice microphone 4 is provided as a “soap on the rope” between the earphones 15A, 15B and the housing 16. The housing 16 comprises a Bluetooth transceiver, control circuit, headset buttons 26 and an ambient microphone 6. The headset system 1B is wirelessly connected to a mobile phone 10 via a Bluetooth link 20.

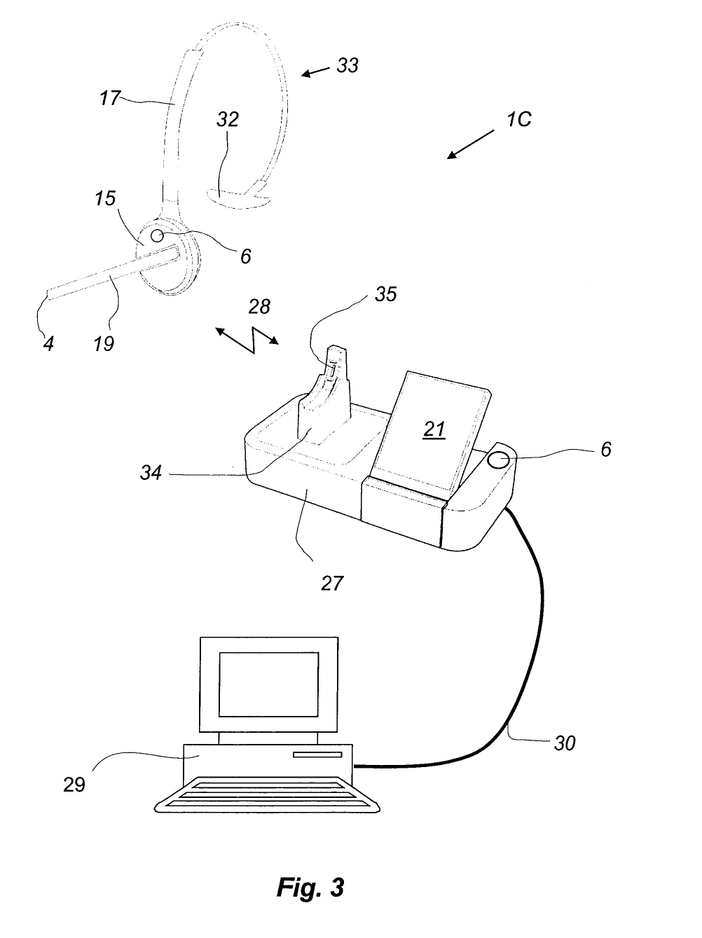

FIG. 3 discloses a third embodiment of a headset system 1C according to the disclosure. This headset system 1C is designed for office use. It comprises a wireless headset 33 and a corresponding headset base 27. The headset system 1C is following the DECT standard and the headset 33 and the headset base 27 each comprise a DECT transceiver, whereby they during use are interconnected by a DECT link 28. The headset 33 comprises a headband 17 with an earphone 15 at one end and an end piece 32 at the other end. A microphone boom 19 extends from the earphone 15 in the direction of the user's mouth during use, and a voice microphone 4 is provided at the free end of the microphone boom 19. An ambient microphone 6 is provided on the earphone 15. The headset base 27 is adapted to stand on a desktop and comprises a headset cradle 34 with charging contacts 35 for receiving the headset 33, when this is not in use. The headset base 27 furthermore comprises a touch display 21 as user interface. The headset base 27 is by means of a cord 30 connected to a desktop computer 29 which is connected to the Internet and includes appropriate telephony software.

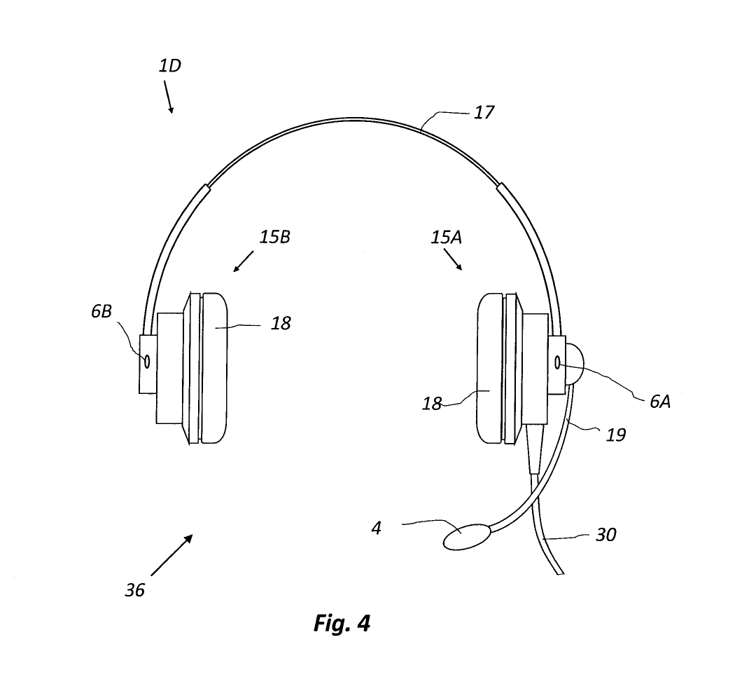

FIG. 4 discloses a fourth embodiment of a headset system 1D according to the disclosure. The headset system 1D comprises a corded headset 36 with two earphones 15A, 15B that are interconnected by a headband 17. Each earphone 15A, 15B comprises an ear pad 18 for enhancing the user comfort and blocking out ambient sounds during two-way communication. A cord 30 extends from the first earphone 15A to a not-shown desktop phone. Also, a microphone boom 19 with a voice microphone 4 at the free end extends from the first earphone 15A. The housing of the first earphone 15A comprises a first ambient microphone 6A and the housing of the second earphone 15B comprises a second ambient microphone 6B. During telephone conversations the ambient microphones 6A, 6B are switched off so that the user only hears ambient noise, which is picked up by the voice microphone 4. When the user is not on a call, the voice microphone 4 is switched off while the ambient microphones 6A, 6B are switched on whereby the user is not acoustically isolated from the surroundings. Sound from the first ambient microphone 6A is directed to the speaker of the first earphone 15A, and sound from the second ambient microphone 6B is directed to the speaker of the second earphone 15B. Thus, the user experiences a spatial effect, whereby he is able to hear form which direction ambient sounds are coming.

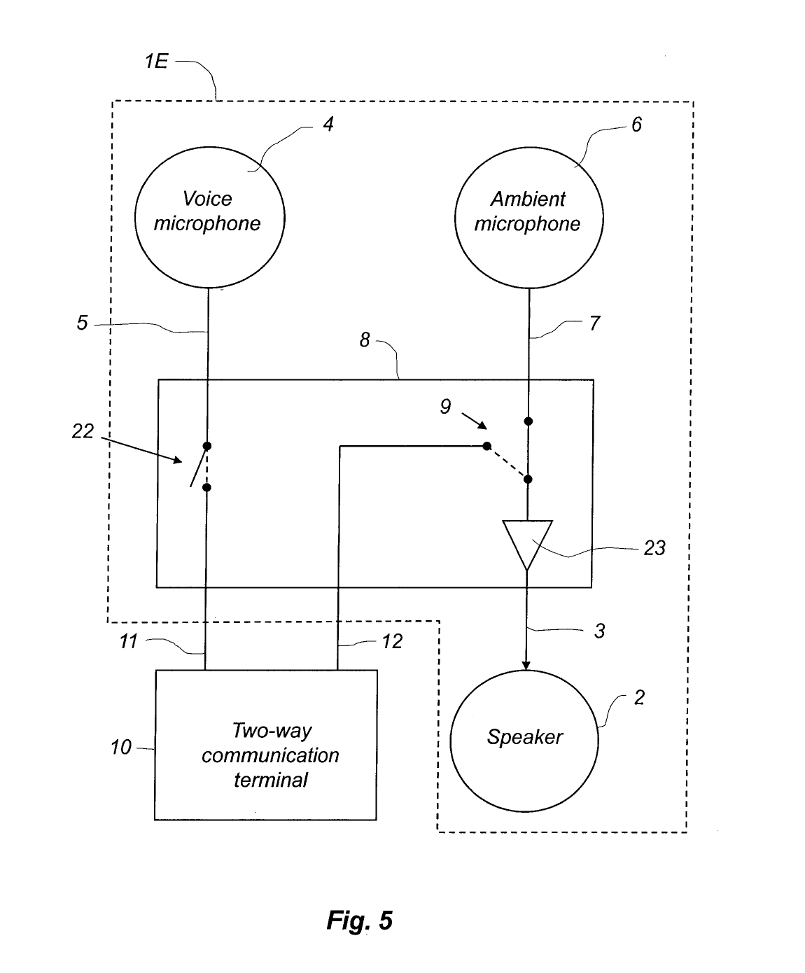

FIG. 5 is a diagram schematically showing parts of the headset system 1E according to a fifth embodiment of the disclosure. The headset system 1E comprises a voice microphone 4, an ambient microphone 6, a speaker 2 and a control circuit 8. The control circuit 8 receives a voice signal 5 from the voice microphone 4 and an ambient sound signal 7 from the ambient microphone 6. A speaker signal 3 is directed from the control circuit 8 to the speaker 2. The control circuit 8 is also connected to a two-way communication terminal 10, such as a desktop phone, mobile phone or soft phone. Thus, the control circuit 8 sends an output signal 11 comprising the voice signal 5 to the two-way communication terminal 10 and receives an input signal 12 from the two-way communication terminal 10. A voice signal switch 22 is provided to switch on and off the voice signal to/from the output signal 11. A mode switch 9 is provided for switching the headset system 1E between an ambient mode in which the speaker signal 3 comprises the ambient sound signal 7 and not the input signal 12 (or the signal attenuated in whole or in part) and a communication mode in which the speaker signal 3 comprises the input signal 12 and not the ambient sound signal 7 (or the ambient sound signal attenuated in whole or in part.). Thus, in the ambient mode, the user can hear ambient sounds picked up by the ambient microphone 6 only, and in the communication mode, the user can hear the input signal 12 coming from the two-way communication terminal 10 only. The switching can be manual or automatic. When manual, the user can f. ex. press a button on the headset to change mode, and when automatic, the communication mode is automatically selected when there is an input signal 12 from the two-way communication terminal 10 or with the input level reaches a certain predetermined level. A speaker amplifier 23 is provided to amplify the speaker signal 3 to an suitable level. In FIG. 5, the headset system 1E is in the ambient mode. The voice signal switch 22 is operatively connected to the mode switch 9, so that the voice signal 5 is automatically switched off from the output signal 11, when the headset system 1E is in the ambient mode.

If is further possible for the user to select the attenuation level of either signal (most likely the ambient) so the user may maintain awareness of surroundings even during a conversation.

Furthermore, the user may have a predetermined level of ambient sound maintained when the user is speaking but full or greater attenuation when the user is listening. Again this would give the user greater awareness of background activities.

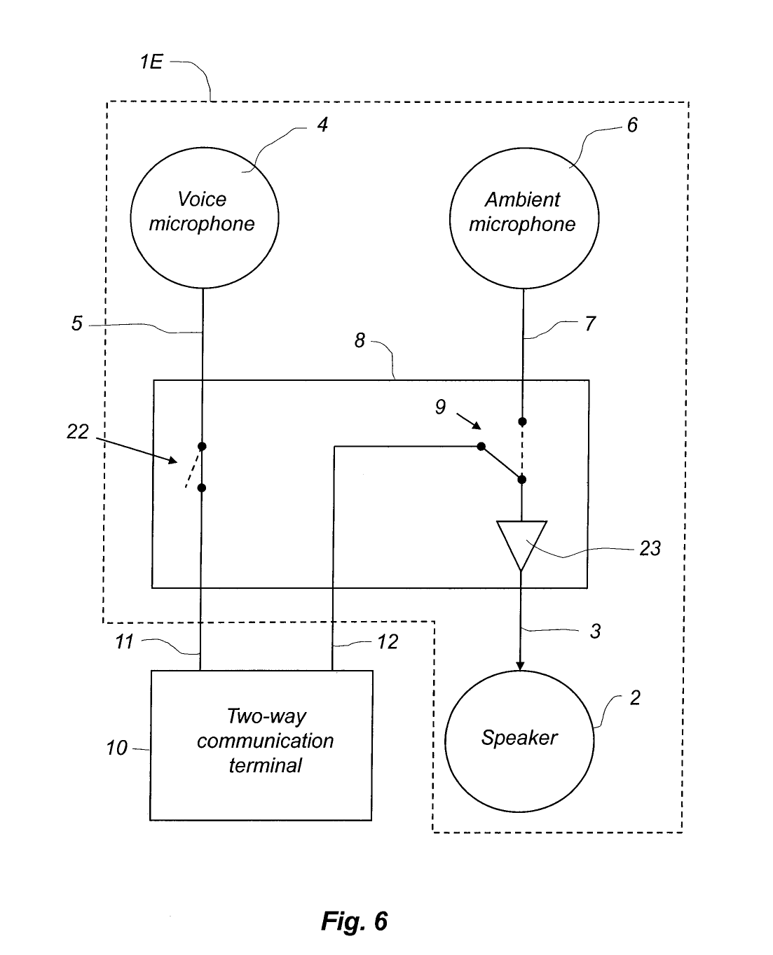

FIG. 6 discloses the headset system 1E according to the fifth embodiment in the communication mode.

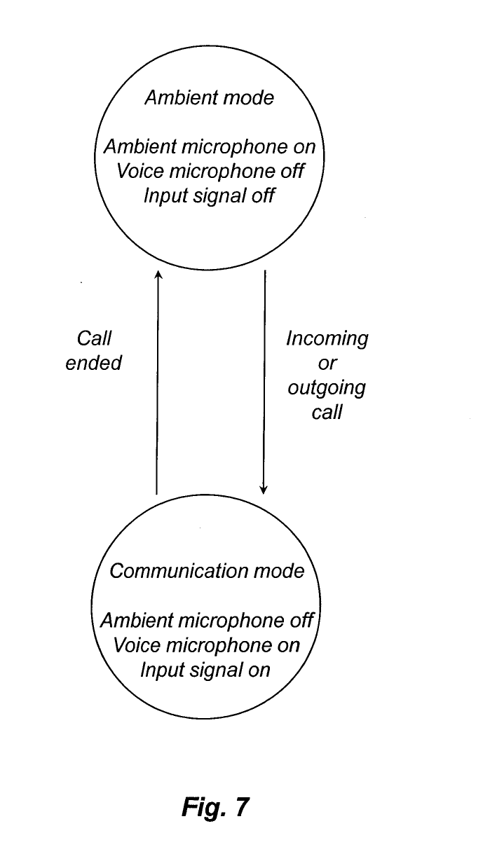

FIG. 7 is a state machine showing the two states or modes of the headset system 1 according to the disclosure. In the uppermost ambient mode, the ambient microphone is switched on, while the voice microphone and the input signal are switched off. In the lowermost communication mode, the ambient microphone is switched off while the voice microphone and the input signal are switched on. The left arrow indicates that the headset system switches from communication mode to ambient mode when a call is ended. The right arrow indicates that the headset system switches from ambient mode to communication mode, when there is an incoming or outgoing call.

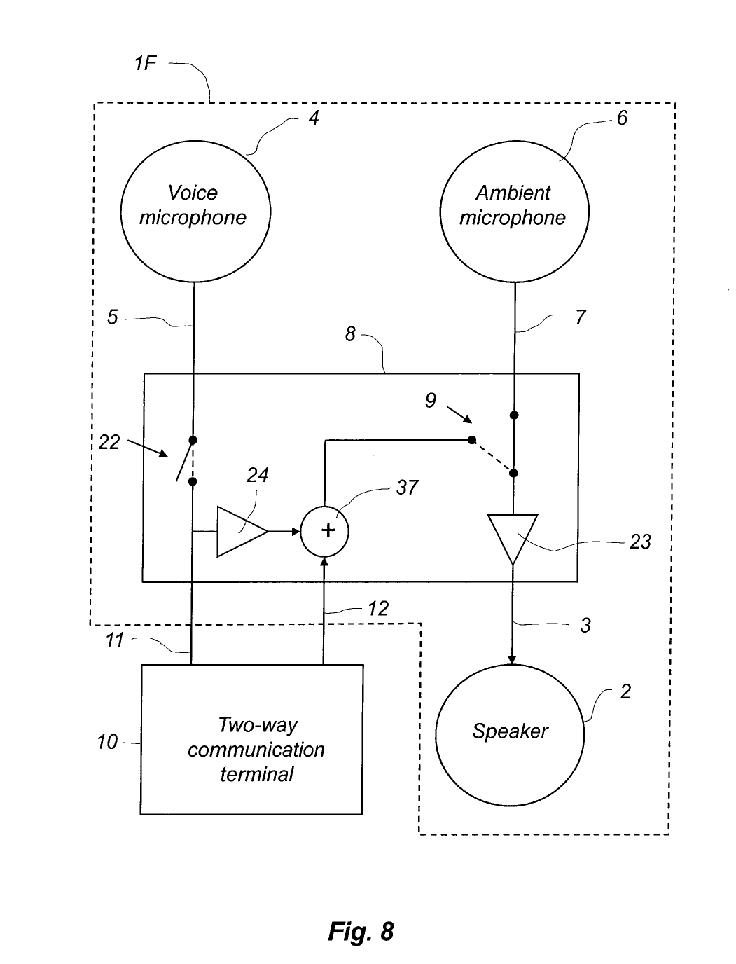

FIG. 8 is a schematic diagram of a sixth embodiment of a headset system 1F according to the disclosure in ambient mode. This headset system differs from the one shown in FIGS. 5 and 6 by having a so-called “sidetone” feature. This means that the user can hear his own voice picked up by the voice microphone 4 during two-way communications. The voice signal 5 is via a voice signal amplifier 24 directed to an input of an adder 37 and thereby added to the input signal 12. In quieter environments, as determined by the ambient microphones, the system can increase the sidetone level (the amount of the user's own voice feed back to the users own earphones, so that the user is thereby likely to speak more softly and thus not disturb others.

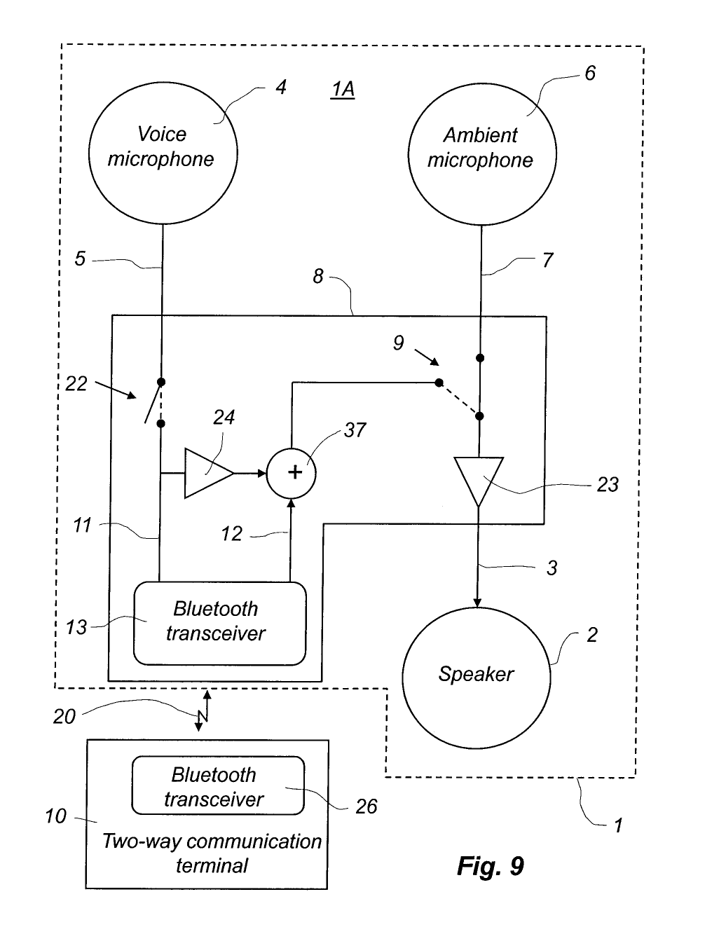

FIG. 9 is a schematic diagram of the headset system 1A according to the first embodiment, in which the connection between the earphone 15 and the two-way communication device 10 is provided by a Bluetooth link 20. In order to obtain this, the headset 1A comprises a first Bluetooth transceiver 13 while the two-way communication device 10 comprises a second Bluetooth transceiver 26.

The embodiments shown here are only examples of the disclosure. In all embodiments, the mode switch can be manual or automatic. Also, if automatic, the user may be able to override, so that the user, during a call, can temporarily or momentarily listen to ambient sounds before returning to the call. The automatic switching can be obtained by a small relay or electronic switch, that detects when there is an input signal 12 of certain predetermined strength.

Consequently, a user of a headset, would be able to hear the ambient environment even though the headset may be tight fitting and otherwise block the user's hearing.

The switching between ambient and communications mode could also allow for ambient mode to resume in the midst of a communication but where there is a silent period for a predetermined period of time. The control would monitor the communications and when its amplitude dropped below a certain threshold for a predetermined period, the ambient sound , or an attenuated portion thereof, would be re-introduced until the communications signal level exceeded the threshold again. This would allow the user to regain awareness of surroundings.

Likewise the ambient mode could result despite communications over the headset if a predetermined protocol were set for such override. For example, if an automobile were equipped to send a predetermined tone or frequencies (audible or subaudible) or an infrared or radio signal, the ambient mode would resume. An example might be in the case of a crash avoidance system where the auto would first emit a wake up signal (such as an attention tone) which would trigger the ambient mode in the headset. This would insure that the driver would hear the warning message despite having his/her ear blocked by a headset. Such systems might become mandatory for headset users.

The ambient mode could be coupled with filters to cancel repetitive noises (motor, ventilator, road) and pass only sounds such a voice an emergency sounds. In addition, the filter could be pre-programmed to watch for a “pattern match” of certain warning signals (sirens, tire squeal, etc,) and automatically engage ambient mode (simultaneously with communications mode) as an emergency override system.

Ambient sound detection could be used for noise suppression during communications mode. Loud background noises will enter into the communications microphone. By using the ambient microphone(s) for sound pickup, inverted phase (or other) noise detection and suppression could be applied.

### LIST OF REFERENCE SIGNS

1 headset system
2 speaker
3 speaker signal
4 voice microphone
5 voice signal
6 ambient microphone
7 ambient sound signal
8 control circuit
9 mode switching circuit
10 two-way communication device
11 output signal
12 input signal
13 headset Bluetooth transceiver
14 two-way communication terminal Bluetooth transceiver
15 earphone
16 body worn headset housing
17 headband
18 ear pad
19 microphone boom
20 Bluetooth link
21 user interface
22 voice signal switch
23 speaker amplifier
24 voice signal amplifier
25 headset cord
26 headset buttons
27 headset base
28 DECT link
29 computer with softphone
30 wire
31 user
32 end piece
33 headset
34 headset cradle
35 charging contacts
36 headset
37 adder

1. A communication headset system (1) for connecting to a two-way communication device (10), said communication headset system (1) comprising an earphone (15) with a speaker (2) for receiving a speaker signal (3) and converting it into speaker sound,
a voice microphone (4) for receiving a user's voice and converting it into a voice signal (5),
an ambient microphone (6), arranged at a distance from the voice microphone (4), for receiving ambient sound and converting it into an ambient sound signal (7), a control circuit (8) for receiving the ambient sound signal (7) and an input signal (12) from the telecommunication device (10), and for transmitting the speaker signal (3) to the speaker (2),
wherein the control circuit (8) comprises a mode switching circuit (9) for switching the headset system between an ambient mode in which the speaker signal (3) comprises the ambient sound signal (7) with the input signal (12) attenuated and a communication mode in which the speaker signal (3) comprises the input signal (12) and not the ambient sound signal (7), and wherein the control circuit (8) is adapted to automatically enter the communication mode when it receives an input signal (12) from the two-way communication device (10).

2. A communication headset system (1) according to claim 1, wherein the control circuit (8) is adapted to transmit an output signal (11) comprising the voice signal (5) to the two-way communication device (10) in the communication mode.

3. A communication headset system (1) according to claim 1, wherein a user interface (21) is provided for switching between the ambient mode and the communication mode.

4. A communication headset system (1) according to claim 1 wherein the control circuit (8) is adapted to automatically enter the communication mode when it receives an input signal (12) from the two-way communication device (10) of a predetermined amplitude and revert to ambient mode when said signal drops below said predetermined amplitude for a predetermined period of time.

5. A communication headset system (1) according to claim 1, comprising a first earphone (15A) and a second earphone (16B).

6. A communication headset system (1) according to claim 5, wherein the first earphone (15A) and the second earphone (16B) are interconnected by a headband (17) or a neckband.

7. A communication headset system (1) according to claim 1, wherein the communication headset system (1) comprises a headset housing (15; 16; 27), which comprises the ambient microphone (6).

8. A communication headset system (1) according to claim 7, wherein the headset housing (16; 27) is separate from the earphones (15A, 15B).

9. A communication headset system (1) according to claim 8, wherein the headset housing is a body worn housing (16).

10. A communication headset system (1) according to claim 8, wherein the headset housing is a headset base (27) adapted to be placed on a surface, such as a desktop or a wall, during use.

11. A communication headset system (1) according to claim 1, wherein an earphone (15) comprises the ambient microphone (6).

12. A communication headset system (1) according to claim 5, wherein each of the first earphone (15A) and the second earphone (15B) comprises an ambient microphone (6).

13. A communication headset system (1) according to claim 1, wherein the voice microphone (4) is arranged on a microphone boom (19).

14. A communication headset system (1) according to claim 1, wherein the control circuit is (8) is adapted to add the voice signal (5) to the speaker signal (3) in the communication mode.

15. A communication headset system (1) according to claim 1, wherein the ambient microphone (6) is omnidirectional.

16. A communications headset according to claim 8 wherein the control circuit includes a user selectable threshold control whereby the switching to automatic mode occurs when the input signal exceeds a predetermined level.

17. A communications headset according to claim 8 wherein the control circuit includes a threshold control configured so that the ambient signal is supplied to the headset, even in communications mode during quite periods.

18. A communications headset according to claim 17 wherein the ambient signal is supplied at an attenuated level.

19. A communications headset according to claim 1 wherein the control circuit includes a pattern matching algorthim configured to recognize a predetermined set of critical sound pattern, and pass ambient sound containing such patterns even during communications mode, so that the user is appraised of critical sounds.

20. A communications headset according to claim 8 wherein the control circuit includes noise cancelling circuits to cancel ambient noise picked up by the voice microphone in communications mode.

21. A communications headset according to claim 8 wherein the control circuit includes the capability to detect ambient noise falls to levels below a predetermined level and the increase the sidetone injection of amount of user's voice feed back into the headset.

22. A method of increasing user awareness of external environment when hearing a communication headset system having an earphone with a speaker for receiving a speaker signal and converting it into speaker sound, a voice microphone (4) for receiving a user's voice and converting it into a voice signal (5), an ambient microphone (6), for receiving ambient sound and converting it into an ambient sound signal (7), a control circuit (8) for receiving the ambient sound signal (7) and an input signal (12) from the telecommunication device (10), and for transmitting the speaker signal (3) to the speaker (2), the method comprising the steps of;
a. feeding the ambient signal into the user's earphone;
b. monitoring the threshold level of the input signal;
c. at a predetermined threshold, attenuating the ambient signal in favor of the input signal;
d. restoring the ambient signal when the input signal drops below a predetermined level for a predetermined length of time.

23. The method of claim 22 further including the step of:
a. storing at least one sound pattern;
b. monitoring the ambient signal for said pattern;
c. passing the ambient signal which includes the said sound pattern to the earphone regardless of whether the ambient signal was previously attenduated by the presence of an input signal;
wherein the control circuit (8) comprises a mode switching circuit (9) for switching the headset system between an ambient mode in which the speaker signal (3) comprises the ambient sound signal (7) with the input signal (12) attenuated and a communication mode in which the speaker signal (3) comprises the input signal (12) and the ambient sound signal (7) attenuated.
